(19) United States
(12) Patent Application Publication
(10) Pub. No.: US 2007/0261105 A1
(43) Pub. Date: Nov. 8, 2007

(54) Method for License Allocation and Management

(75) Inventors: Rainer Drath, Weinheim (DE); Georg Gutermuth, Heidelberg (DE)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD., ZURICH (CH)

(21) Appl. No.: 11/792,919

(22) PCT Filed: Dec. 15, 2005
(86) PCT No.: PCT/EP05/13481

§ 371 Date: Jun. 13, 2007

(30) Foreign Application Priority Data
Dec. 17, 2004 (DE) 10 2004 060 784.2

(51) Int. Cl. G06F 21/22

(52) U.S. Cl. 726/4

(57) ABSTRACT

The invention relates to a method for allocation and management of a usage permit for software in a computer network, comprising at least one server and several clients, whereby the software may be called up by several or all clients. The use of the installed software is only permitted in the clients during the period of validity of a usage permit requested from the server, whereby clients communicate with the server by means of a network connection, at least for the permit request. Usage permits are allocated by the server according to conditions of a network license which either relates to a permit for simultaneous use of the software by an agreed maximum number of clients for an agreed total duration of software use. The allocation of a use permit by the user is achieved by means of a token which authorizes a use of the software in the corresponding client, said usage permit expiring on return of the token or on expiry of a validity period for the token.

### DESCRIPTION

The invention relates to a method for allocating and managing network software licenses. The method can be used in computer networks for flexible allocation of software licenses.

When software is sold, normally it is not the software itself that is sold but a software license. Software licenses constitute a usage agreement that is intended to protect the vendor from unauthorized use or duplication, in particular.

One way of classifying protective measures is as passive or active software protection. Passive software protection is provided when the vendor trusts the customer to use the software correctly. This is often the case for end-customer software, for example for office products, tax calculation programs, photo management software or other frequently used products. The term “passive” is used here in the sense that there are no actual protective mechanisms preventing unauthorized use or distribution.

Active software protection is provided when the vendor equips the software or data storage medium with mechanisms that hamper or prevent unauthorized use or distribution. The following methods are used in practice for this purpose:

a) for protecting single-user licenses:
expiry date: after installation, the software is given a validity period within which it operates with an extended range of functions, but once this period has expired, the functions are limited or suspended. This is an established method for shareware or demo versions, in order to give the customer the opportunity to check out the functions of a software package. The software can be activated later by purchasing a “full version” or entering an activation code.
copy protection of the data storage medium: special mechanisms are used to protect the data storage medium against unauthorized duplication. This method is frequently used for end-customer software, but has the disadvantage that the software can still be installed on other computers without permission by using the original data storage medium. In addition, copy-protection mechanisms are often neutralized by special mechanisms so that copying can be carried out in practice despite copy protection.
unassociated registration key: the customer receives a code which is used to activate the software. Unauthorized circulation and use of the software cannot occur without this code. If, however, the code is disclosed, protection is ineffective.
associated registration key: the customer receives a code that has been computed from personal information. Examples of personal data used for this purpose are the name of the user (the software is then associated with the user) or identifying features of the computer, for example the hard disk volume number, the globally unique MAC ID of the network card or combinations of the two (the software is then associated with the hardware). The person-associated method is already established for PDAs (e.g. PalmPilot), for example, and is effective protection against unwanted duplication. The hardware-associated registration has the disadvantage that the software is tied to one computer, and changing a computer (e.g. new purchase) results in software failure.
dongle: the customer receives along with the software a piece of hardware that is connected to a PC and activates the software when the software is run. This constitutes another hardware-associated software protection method, and has the advantage that it can be transferred from computer to computer.

b) for protecting multiple-user licenses:
license server with fixed assignment: the customer receives an allocation of software licenses that are managed by a central license server. The licenses are assigned to specific computers or users so that only authorized installations are activated. On running an installed program, the license server decides whether the software is activated. This provides an effective means of preventing unauthorized installation on other computers or use of the software by unauthorized persons. Being tied to a specific computer, however, is often restrictive, for example when replacing a computer.
license server with flexible assignment: the customer receives an allocation of software licenses that are managed by a central license server. The licenses are not assigned to specific computers; only the number of applications that are running is monitored. Hence the software can be installed any number of times within a network; the number of times that the software can be run simultaneously, however, is limited by the software licenses available. The user runs his software and establishes a connection to the license server via the network. The server detects the software start-up and reduces the tally of licenses available. When the software is closed, this is again detected by the license server, and the number of available licenses is re-incremented. The advantage of this method is that by time-shifted use of the licenses, more employees can use the software than licenses purchased. This is particularly advantageous for software products that are only used occasionally. In such applications, this method therefore reduces software costs.
all-inclusive network license: with this method, the customer receives an all-inclusive allocation of software licenses for frequently used products (e.g. office products). All computers on the network can use the software. A central license server is not needed. This form of network license is often used in universities, for example (“campus licenses”), or in companies with all-inclusive contracts for standard products. Protection against unauthorized duplication is low however.

Network licenses where licenses are allocated by license servers have become established for multiple use of software, and provide effective software protection. For particularly high-value software, some vendors even provide the license server themselves (for example via the Internet), so that contact must be established with the vendor whenever the software is run. Although being tied to the network protects the software vendor from commercial loss, it does restrict flexible use of the software.

A serious disadvantage of network licenses lies in being tied to the network. If the network fails or the computer disconnects from the network, the software is no longer guaranteed to run. If the license server or the network is unavailable, or if the user is using his computer on the move and has no network access, the software cannot be used.

Hence the object of the invention is to define a method for allocating and managing network licenses that requires no permanent connection to a license server.

This object is achieved by a method for allocating and managing network software licenses that has the features given in claim 1. Advantageous embodiments are given in additional claims.

As described in the claims, two method versions are proposed by the invention that combine software protection methods for the single-user license case and those methods for the network license case. Although the method versions differ in terms of the underlying license conditions in each case, the principle behind them employs the same inventive measures in order to enable continued software use even when the network connection is lost. This is achieved by a license server allocating a use permit in the form of a token, which attaches a limit on the usage period to the respective use permit.

One of the advantages of the method according to the invention is that it enables more flexible use of the licensed software while still meeting the protection requirement of the software vendor thanks to the time limit to the use permit. A network connection between a computer using the licensed software and the license server is only required while the respective use permit is being requested and allocated. It is thereby possible to use the software independently of the network.

The invention and its advantages are explained further in the description given below of an exemplary embodiment with reference to drawing figures, in which

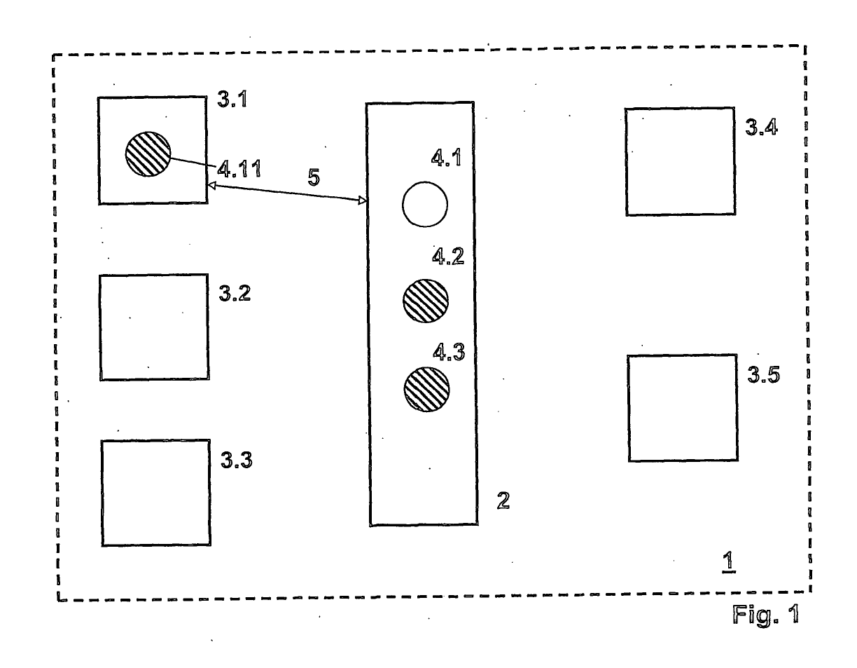

FIG. 1 shows a computer network having a number of network licenses, and

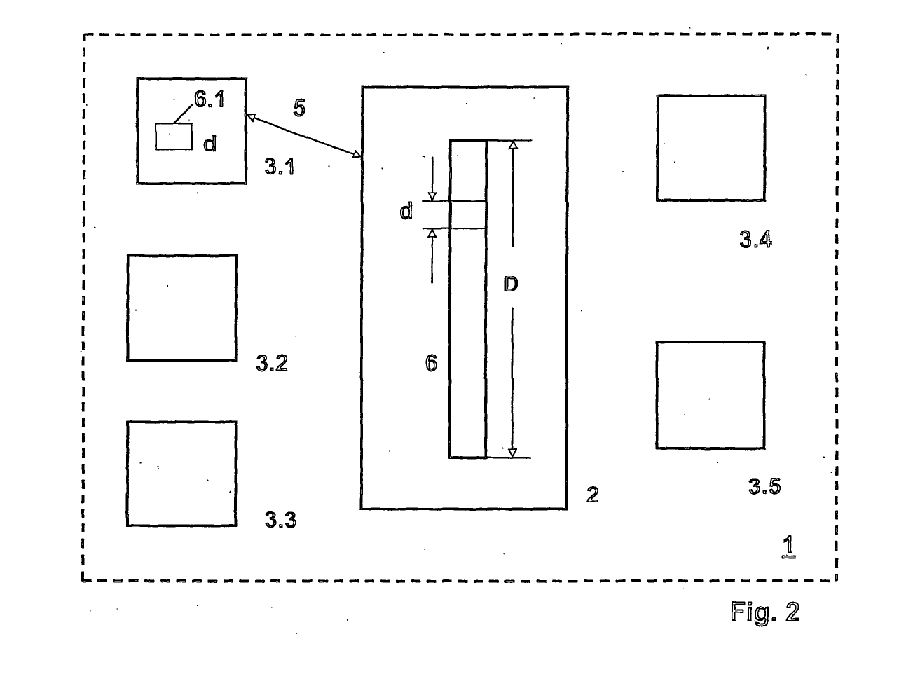

FIG. 2 shows a computer network having a timeframe for a network license.

FIG. 1 shows a computer network 1 containing a license server 2 and five client computers 3.1 to 3.5, referred to here for short as server and client respectively.

The server 2 allocates and manages under software control three software licenses 4.1 to 4.3, which are not assigned to specific clients. The licensed software is installed in all the clients that need the software, although because of the license condition, only a maximum of three clients are allowed to use the software simultaneously. The shaded areas represent the use permits for the licensed software, where FIG. 1 shows a situation in which the client 3.1 is granted a temporary use permit based on the license 4.1.

In order to obtain such a usage permit or use permit, the respective client, in this case client 3.1, requests the permit from the server 2 via a network connection 5. If all three licenses have not yet been allocated, the server 2 grants the permit by means of a token, which is assigned an expiry date, i.e. it loses its validity after a specified period, e.g. 30 days. After transferring the token to the client, e.g. 3.1, a use permit 4.11 remains stored there, for example for 3 days. The client 3.1 can hence be disconnected from the network after receiving the token, and still use the software until the 30 day period expires.

If a network connection is restored prior to expiry of the validity period of e.g. 3 days, an extension to the use permit can be obtained without stopping the application. If, however, no new request is made, the use permit expires and the software is deactivated in client 3.1.

In the server 2, the number of available licenses was decremented from 3 to 2 at the same time as the use permit 4.11 was allocated. After expiry of the validity period of the use permit 4.11, the number of available licenses is re-incremented to 3 in the server 2. If a network connection 5 exists, the token, i.e. the use permit, can also be returned early, whereupon likewise, use of the software is deactivated in the client returning the token, and the number of available licenses is incremented in the server.

The specified aim of adhering to the license conditions, and the facility for flexible use of the licenses, plus the reduced necessity for a network connection, is achieved by the method described. The procedures for software activation and deactivation also run under software control in the clients, apart from requesting the token and its early return.

FIG. 2 shows the same structure of an exemplary computer network 1 as FIG. 1, having software installed in all the clients 3.1 to 3.5. This example is based on a different license agreement, however. A license 6 specifies that the software is allowed to be used simultaneously in all the clients 3.1 to 3.5, but only until an agreed total period D is reached. In order to ensure this, the clients 3.1 to 3.5 must request from the server 2 a temporary use permit, e.g. 6.1. The respective client, e.g. 3.1, subsequently receives by means of a token a temporary use permit 6.1 having an agreed validity period d. In this method version it is again possible to dispense with a network connection after receiving the token, and to use the software until validity period d expires. It shall be understood that both an early token return and a validity extension are also possible for this version in the manner described above.

In order to determine the remaining validity period according to the license, each time a use permit expires, the period d is subtracted from the current remaining validity period in the server, or if the token is returned early, a correspondingly shorter usage period is subtracted. Once again for this method version, once the use permit is removed, use of the licensed software is deactivated.

In both method versions shown in FIG. 1 and FIG. 2, it is straightforward to determine the percentage usages made by individual clients of the software license, for example in order to allocate costs. If payment is to be made to the license-giver at defined periods according to the actual extent of software usage, then this extent, which is immediately obvious, can also be determined easily.

List of References

0 Computer network
0 Server
2.0 to 3.3 client
4.1 to 4.3 licenses
4.11 temporary use permit
5 network connection
6 network license
5.0 temporary use permit
D total period of software use agreed when license taken
d sub-period of software use

1. A method for allocating and managing a use permit for software in a computer network, comprising at least one server and a plurality of clients, wherein
a) the software can be invoked by a plurality of clients or all the clients,
b) invocation of the software is only permitted in the clients during the validity period of a use permit that can be requested from the server, wherefor clients communicate with the server via a network connection at least for the permit request.
c) use permits are allocated by the server according to conditions of a network license, which relates either to a permit for simultaneous use of the software by an agreed maximum number of clients, or to a permit for use of the software by any number of clients during an agreed total period of software use, and
d) the allocation of a use permit by the server is achieved by means of a token, which authorizes use of the software in the respective client, said use permit expiring either on the return of the token or on expiry of a validity period of the token.

2. The method as claimed in claim 1, wherein the network license relates to a permit for simultaneous use of the software by an agreed maximum number of clients, and the number of use permits that can be allocated is decremented in the server simultaneously with each transfer of a token until either the token is returned by the respective client, or the validity period has expired, whereupon the number of use permits that can be allocated is re-incremented.

3. The method as claimed in claim 1, wherein the network license relates to a permit for use of the software by any number of clients during an agreed total period of software use, and in the server, individual usage periods of all the clients are summed, and no further use permits allocated if the agreed total period is reached, each of the individual usage periods of the clients being obtained from the usage period between token transfer and token return or—if the token is not returned—expiry of the token validity period.

4. The method as claimed in claim 1, wherein by communication of the clients with the server, in each case prior to expiry of the validity period of an existing token, the use permit can be extended by requesting a further token.

5. The method as claimed in claim 2, wherein by communication of the clients with the server, in each case prior to expiry of the validity period of an existing token, the use permit can be extended by requesting a further token.

6. The method as claimed in claim 3, wherein by communication of the clients with the server, in each case prior to expiry of the validity period of an existing token, the use permit can be extended by requesting a further token.
